(19) United States
(12) Patent Application Publication
(10) Pub. No.: US 2025/0162918 A1
(43) Pub. Date: May 22, 2025

(54) Method for Treating Ground Water

(71) Applicant: Douglas Day, Plymouth, MI (US)

(72) Inventor: Douglas Day, Plymouth, MI (US)

(21) Appl. No.: 18/956,044

(22) Filed: Nov. 22, 2024

Related U.S. Application Data
(60) Provisional application No. 63/602,287, filed on Nov. 22, 2023.

(51) Int. Cl. C02F 9/00; C02F 1/00; C02F 1/68; C02F 1/72; C02F 1/78; C02F 101/20; C02F 101/34; C02F 103/06

(52) U.S. Cl. CPC C02F 9/00; C02F 1/004; C02F 1/68; C02F 1/722; C02F 1/78; C02F 2101/203; C02F 2101/34; C02F 2103/06; C02F 2303/04; C02F 2303/16

(57) ABSTRACT

An improved method for removing contaminants, such as 1,4 dioxane, from ground water using an advance oxidation process. The improved method uses a controlled injection of monochloramine into the effluent in an amount that suppresses formation of bromates but does not interfere with the oxidative destruction of 1,4 Dioxane destruction. Removing iron from the effluent with a sand filter further improves the removal of bromates from the treated water.

### RELATIONSHIP TO OTHER APPLICATION

This application claims the benefit of the filing date of U.S. Provisional Patent Application Ser. No. 63/602,287 filed on Nov. 22, 2023. The disclosure in the identified United States Applications is incorporated herein by reference.

### BACKGROUND OF THE INVENTION

### Field of the Invention

This invention relates generally to a method of treating ground water, and more particularly, to an improved advanced oxidation process.

### Prior Art

Advanced oxidation processes (AOPs) are chemical treatment procedures designed to remove organic, and sometimes inorganic, materials in water and wastewater by oxidation through reactions with hydroxyl radicals. For wastewater treatment, this usually refers to chemical processes that employ primary oxidants, such as ozone (O₃) or hydrogen peroxide (H₂O₂) and/or energy sources, e.g., UV light, or catalysts, to create hydroxyl radicals. The term advanced oxidation process as applied to wastewater treatment was first used by Glaze, et al., “The Chemistry of Water Treatment Processes Involving Ozone, Hydrogen Peroxide and Ultraviolet Radiation,” Ozone: Science & Engineering, Vol. 9, No. 4, pages 335B352 (1987). Since then, AOPs have been investigated and employed in various embodiments in the treatment of municipal water and wastewater.

The hydroxyl radicals produced by AOPs are powerful oxidants that are able to destroy 1,4-dioxane, among other contaminants, in wastewater. 1,4-Dioxane is a highly soluble, synthetic chemical used as a solvent and chlorinated solvent stabilizer for industrial chemicals. It can also be found in many consumer products such as deodorants, shampoos, and toothpastes. However, dioxane has been classified by the EPA as likely to be carcinogenic to humans. Therefore, many jurisdictions require its removal from the water supply due to its potential risk to human health.

Presently, AOP is the only treatment method that has been shown to effectively remove the contaminant 1,4-dioxane from wastewater. However, if bromide ions are present in the waste water or effluent, the oxidative process can produce a bromate. This is particularly true when ozone is used as an oxidant. A bromate is a chemical compound that contains the oxyanion, BrO₃-, illustratively sodium bromate, (NaBrO₃) or potassium bromate (KBrO₃). Therefore, bromates can occur in treated drinking water. This is undesirable because bromates are also suspected human carcinogens. There is, thus, a need to reduce the amount of bromate formed during the oxidative destruction of 1,4-dioxane by an AOP.

### SUMMARY OF THE INVENTION

In accordance with the methods of the present invention, the formation of bromates during the destruction of 1,4 dioxane in the treatment of ground water by an AOP can be mitigated by careful control and input of monochloramine and, if iron is present in the ground water, by removal of the iron with a sand filter.

Monochloramine (NH₂Cl), together with dichloramine (NHCl₂) and nitrogen trichloride (NCl₃), are the three chloramines of ammonia. Monochloramine is often used as a disinfectant for water. It is less aggressive than chlorine and more stable against light than hypochlorites, such as sodium hypochlorite (NaOCl), commonly known in a dilute solution as chlorine bleach. However, monochloramine has not been widely used in ground water processing by AOPs.

In an improvement on an AOP for removal of 1,4 dioxane, a closely controlled injection of monochloramine into the influent line of ground water that has been subjected to the oxidant hydrogen peroxide and prior to subjecting the treated effluent to an injection of the oxidant ozone suppresses the formation of bromate while destroying 1,4 dioxane.

If iron is present the ground water, removal of the iron from the treated effluent with a sand filter further reduces the production of bromates.

### BRIEF DESCRIPTION OF THE DRAWING

Comprehension of the invention is facilitated by reading the following detailed description, in conjunction with the annexed drawings, in which:

FIG. 1 is a schematic diagram showing the input of monochloramine in an illustrative AOP treatment process of groundwater; and

FIG. 2 is a chart showing the intended pathway interruption in bromate formation.

### DETAILED DESCRIPTION OF THE INVENTION

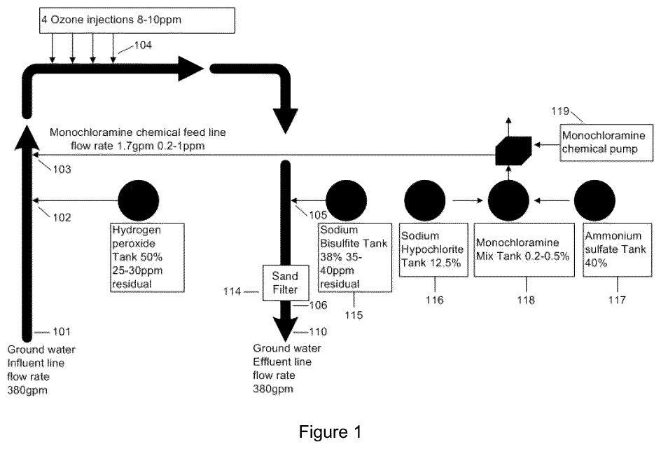

FIG. 1 is a schematic diagram showing an illustrative AOP system for the treatment of ground water with hydrogen peroxide and ozone. Referring to FIG. 1, ground water to be treated enters the system though influent line 101. An oxidant, hydrogen peroxide (H₂O₂), is injected into influent line 101 at injection point 102. Monochloramine (NH₂Cl), produced by mixing a sodium hypochlorite solution (NaOCl; 12.5%) with aqueous ammonium sulfate ((NH₄)₂SO₄; 40%), is fed into influent line 101 at injection point 103. A second oxidant, ozone (O₃), is injected into the resulting effluent at multiple injection points 104.

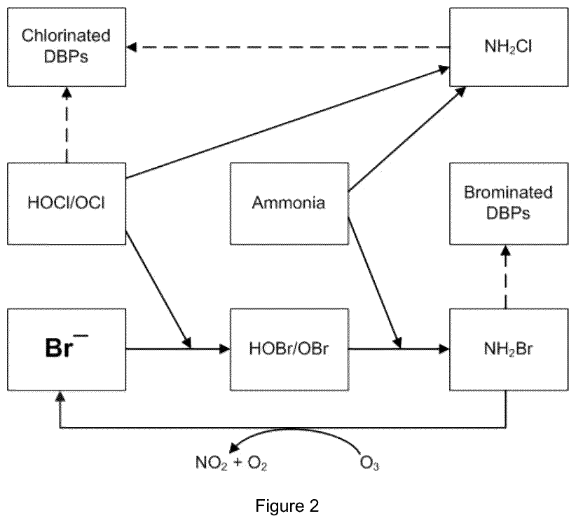

The addition of monochloramine prevents bromide formation and results in the formation of the more stable forms, hypobromous acid (HOBr) and bromamines (NH₂Br) instead of bromate (BrO₃-). FIG. 2 is a chart that shows the intended pathway for interruption of bromate formation by monochloramine. Of course, disinfection by-products (DBPs) as shown in FIG. 2, are formed whenever disinfectants like chlorine or bromine interact with natural organic materials in water. NaHSO₃

Referring back to FIG. 1, the addition of aqueous sodium bisulfite (NaHSO₃; 38%) from sodium bisulfite tank 115 to the effluent line at injection point 105 eliminates the potential for bromate formation by eliminating excess oxidation by-products. Treated ground water effluent, having an acceptably low content of 1,4 dioxane and bromates, exits through effluent line 110.

The addition of a sand filter(s) 114 at point 106 in the effluent line further reduces bromate formation.

### EXAMPLE 1

A 0.1% solution of monochloramine (NH₂Cl) was injected into the influent water in a 1,4 dioxane AOP after peroxide injection and prior to ozone injection as shown in FIG. 1. The injection dosage of monochloramine was controlled at 1-5 ppm with the effluent residual from the AOP being controlled to between 1-2 ppm of monochloramine. Adjustments were made to the ozone dosage to decrease the 1,4 dioxane levels. At the same time, bromate formation was reduced to 2-3 ppb as a result of the monochloramine feed and to as low as 1-3 ppb from iron removal with sand filtering.

It was determined that precise control of the monochloramine solution with a minimal residual of 1-2 ppm simultaneously destroys 1,4 dioxane and reduces bromate formation. The best location for iron removal with the sand filter was located just after the oxidation process.

The exposure time of iron with the effluent water was important. It was determined that bromate formation occurred within 30 minutes after the disinfection process was complete. A 24 hour composite sampling had the highest bromate level. Filtration was tested directly after the process and down stream near the composite sampler with a residence time of 30-60 minutes. It was determined that the iron concentration and exposure time both increased bromate formation. Reducing the iron concentration to <0.5 ppm reduced the bromate formation to 1-3 ppb.

The higher concentration of iron in the effluent being treated, the higher the production of bromate. Therefore, it is important to subject the sand filter to a regular maintenance and cleaning protocol (backwashing) to prevent build-up of a high level of iron in the filter. Maintaining a continuous flow through the sand filter prevents bromate formation from iron retention in the sand.

### EXAMPLE 2

In a pilot test, a temporary chemical feed system was installed to mix the monochloramine solution (see, FIG. 1). An aqueous sodium hypochlorite solution (12.5%) was provided in a 300-gallon tote 116. Aqueous ammonium sulfate (NaHSO₄) 40% by weight was provided in a 55-gallon drum 117. A 265-gallon tote was used as the mix tank 118. Each chemical was pumped with a Pulsafeeder chemical pump (not shown) into mix tank 118 at a rated capacity of 44 gallons per day (gpd). Makeup water (not shown) was metered into the mix tank which activated timers to turn on the chemical pumps (not specifically shown) to feed at a rate to provide a 1000 ppm solution of monochloramine in mix tank 118. Illustratively, each 25 gal of fresh water activated timers for chemical pumps to create monochloramine.

Then, the correct amount of monochloramine was metered into the system with flow meters, or in this case, with chemical pump 119.

A recirculation pump (not shown) was installed on the top of mix tank 118 to provide mixing during the pilot operation. A vent (not shown) was installed to provide removal of fumes from the mix tank to the outside air. In this specific example, two centrifugal pumps (not shown) were installed and connected to the bottom fitting on mix tank 118. One pump 119 was connected to influent line 101 of the oxidation system at injection point 103 and the other connected to a second injection proximate thereto (not specifically shown). Each injection point was provided with a flow meter and a check valve (not shown) to control the amount of monochloramine mixture being fed to the effluent.

Flow rates of monochloramine mixture into the influent line at injection point(s) 103 were established at a range of 0.9 gallons per minute (gpm) to 1.65 gpm. This flow rate is able to provide the calculated preferred dosage of 1 ppm to 5 ppm of monochloramine in the influent to the oxidation system. Adjustments were made throughout the testing period with dosage changes made several times each day. Testing of the water and collecting of samples were done several times each day. The lab evaluated each sample for 1,4 dioxane and bromate in ppb levels. The method of the present invention was able to achieve levels of dioxane as low as 2-3 pbb and levels of bromate from 2 ppb to non-detectable.

Key discoveries from in the pilot study of Example 2 included demonstration of the effect of the oxidation dosages of monochloramine and peroxide. If the peroxide feed was increased to provide an excess of oxidant so that the destruction of 1,4 dioxane was increased, the greater the amount of bromate formation. However, the combination of peroxide and monochloramine, in the right concentrations, resulted in less bromate production. More specifically, the pilot testing was used to determine what dosage range should provide destruction of the 1,4 dioxane while, at the same time, result in low to non-detectable bromate levels in the resulting effluent.

It was determined that there is a specific ratio of hydrogen peroxide to ozone needed to provide excess hydroxyl radicals that could be blocked with monochloramine in order to successfully prevent bromate formation. It was determined that an increase of 5 ppm of hydrogen peroxide and 1.5 ppm ozone provided sufficient excess to provide the hydroxyl radicals needed for reaction with 1 ppm of actual monochloramine. The best performance is demonstrated when a small residual of about 0.3-1 ppm monochloramine is left after oxidation is complete.

Although the invention has been described in terms of specific embodiments and applications, persons skilled in the art can, in light of this teaching, generate additional embodiments without exceeding the scope or departing from the spirit of the invention herein described. Accordingly, it is to be understood that the drawing and description in this disclosure are proffered to facilitate comprehension of the invention, and should not be construed to limit the scope thereof. Moreover, the technical effects and technical problems in the specification are exemplary and are not limiting. The embodiments described in the specification may have other technical effects and can solve other technical problems.

1. A method of treating ground water in an advanced oxidation process using oxidants to destroy 1, 4, dioxane in the ground water, comprising the steps of:
a) subjecting the ground water to an oxidant, which is hydrogen peroxide to create a ground water effluent;
b) adding monochloramine to the ground water effluent in an amount sufficient to suppress formation of bromates in the ground water effluent while not interfering with the destruction of 1,4 dioxane contaminants by the advanced oxidation process;
c) subjecting the monochloramine-treated effluent to a second oxidant, which is ozone, to produce a treated effluent; and
e) adding sodium bisulfite to the treated effluent to eliminate excess oxidation by-products.

2. The method of claim 1 further including directing the sodium bisulfite-treated effluent through a sand filter to remove iron.

3. The method of claim 2 wherein the sand filter is periodically backwashed to remove a build-up of iron in the filter.

4. The method of claim 1 where in the amount of monochloramine added is between about 1-5 ppm.

5. The method of claim 4 wherein the residual amount of monochloramine in the treated effluent is between about 0.3-1 ppm of monochloramine.
